(19) United States
(12) Patent Application Publication
(10) Pub. No.: US 2026/0309191 A1
(43) Pub. Date: Oct. 8, 2026

(54) DRAWN CUP NEEDLE ROLLER BEARING

(71) Applicant: NTN CORPORATION, Osaka (JP)

(72) Inventors: Kazuyuki YAMAMOTO, Shizuoka (JP); Yusuke ASAKAWA, Shizuoka (JP); Kohei DOI, Shizuoka (JP)

(73) Assignee: NTN CORPORATION, Osaka (JP)

(21) Appl. No.: 19/639,737

(22) Filed: Apr. 6, 2026

(30) Foreign Application Priority Data
Apr. 7, 2025 (JP) 2025-063027

(51) Int. Cl. F16C 33/66; F16C 33/64; F16C 33/78

(52) U.S. Cl. CPC F16C 33/6607; F16C 33/64; F16C 33/7816

(57) ABSTRACT

A drawn cup needle roller bearing includes a shell including two flanges; rollers; a sealing member disposed between the rollers and at least one of the two flanges; and a grease-sealed space portion defined by a raceway surface of the shell, axial end surfaces and peripheral surfaces of the rollers, an axial end surface of the sealing member facing the rollers, and an imaginary cylindrical surface inscribed in or circumscribed about the rollers and located on the radially opposite side from the raceway surface with respect to the pitch circle diameter. The distal end of a seal lip faces axially outward.

### TECHNICAL FIELD

The present invention relates to a full-complement drawn cup needle roller bearing.

### BACKGROUND ART

In swinging positions with small swinging angles or positions subjected to high loads, a full-complement drawn cup needle roller bearing, in which a larger number of rollers can be disposed without a cage, is frequently used. In this drawn cup needle roller bearing, sealing members may be disposed at axial ends of the bearing in order to prevent entry of dust or other foreign matter. In addition, grease for lubrication is sealed in the interior of the bearing.

When inserting a rotary shaft into this drawn cup needle roller bearing, this could prevent smooth insertion of the rotary shaft due to the rollers falling off radially inward. For example, in the below-identified Patent Document 1, a rotary shaft 17 is inserted along the center axis of the bearing while a roller fall-off prevention tool 21 is attached to the radially inner side of the needle rollers 2 to prevent the rollers from falling off radially inward (see, in particular, paragraphs 0031 to 0033 and FIGS. 5 to 7 of Patent Document 1).

In this way, although the rotary shaft 17 can be smoothly inserted by using the roller fall-off prevention tool 21, installation of the roller fall-off prevention tool 21 is time-consuming and may lead to an increase in labor costs.

In view of the above, for example, as in a full-complement drawn cup needle roller bearing disclosed in the below-identified Patent Document 2, it is considered that a rotary shaft is inserted while preventing the needle rollers 12 from falling off radially inward by retaining needle rollers 12 using grease G (see, in particular, paragraph 0014 and FIG. 1(b) of Patent Document 2). In addition, for example, as disclosed in the below-identified Patent Document 3, an arrangement is also proposed in which flange portions 22 of an outer ring 2 are formed with roller retaining portions 23 and 24 extending axially inward, protruding portions 32 are formed at both ends of each of needle rollers 3, and the protruding portions 32 engage with the roller retaining portions 23 and 24, thereby retaining the needle rollers 3 in the outer ring 2 (see, in particular, paragraphs 0012 to 0014 and FIG. 1 of Patent Document 3).

### PRIOR ART DOCUMENTS

### PATENT DOCUMENTS

Patent Document 1: Japanese Unexamined Patent Application Publication No. 2018-31420

Patent Document 2: Japanese Unexamined Patent Application Publication No. 2010-133479

Patent Document 3: Japanese Unexamined Patent Application Publication No. 2009-293777

### SUMMARY OF THE INVENTION

### PROBLEMS TO BE SOLVED BY THE INVENTION

As disclosed in Patent Document 2, when the needle rollers 12 are retained by the grease G, it is necessary to use a grease G having a relatively low consistency (a grease G having a certain degree of stiffness). However, the low-consistency grease G is less prone to enter a gap between the rotary shaft and a seal ring 13, and as a result, lubrication may become insufficient.

In addition, as disclosed in Patent Document 3, when the protruding portions 32 formed at both ends of each of the needle rollers 3 are engaged with the retaining portions 23 and 24 formed in the outer ring 2, there is a problem in that load capacity is reduced because the length of a rolling surface of each needle roller 3 relative to its entire length is shortened by the axial lengths of corresponding protruding portions 32, and machining costs associated with forming the roller retaining portions 23 and 24 are increased. In addition, there is also a problem in that it becomes difficult to provide a sealing member due to space limitations by continuously providing the roller retaining portions 23 and 24 on the inner edges of the flange portions 22.

In view of the above, it is an object of the present invention to provide a full-complement drawn cup needle roller bearing in which good lubrication is ensured between a rotary shaft and sealing members while rollers are stably retained with grease.

### Means for solving the Problems

In order to achieve the above object, the present invention provides a drawn cup needle roller bearing of a full-complement type comprising:

a shell having a raceway surface formed on an inner periphery or an outer periphery of the shell, the shell including two flanges formed at two axial ends of the shell, respectively;

a plurality of rollers received in the shell;

a sealing member disposed between the rollers and at least one of the two flanges, the sealing member having a distal end formed with a seal lip; and

a grease-sealed space portion defined by the raceway surface of the shell, axial end surfaces and peripheral surfaces of the rollers, an axial end surface of the sealing member facing the rollers, and an imaginary cylindrical surface inscribed in or circumscribed about the rollers and located on a radially opposite side from the raceway surface with respect to a pitch circle diameter of the rollers,

wherein grease for lubricating the rollers and the sealing member is sealed in the grease-sealed space portion, and a distal end of the seal lip faces axially outward (first arrangement).

With this arrangement, it is possible to ensure good lubrication between the rotary shaft and the sealing member by guiding grease sealed in the grease-sealed space portion toward the distal end of the seal lip of the sealing member while stably retaining the rollers with the grease so as to prevent the rollers from falling off radially inward. In addition, it is possible to seal a larger amount of grease by increasing the inner capacity of the grease-sealed space portion by an amount corresponding to the seal lip facing axially outward, thereby further enhancing lubrication. Further, it is possible to prevent entry of dust into the bearing and to avoid interference between the end surfaces of the rollers and the seal lip, thereby reducing an increase in sliding resistance.

In the first arrangement, a second arrangement may be used in which a grease having a consistency within a range of 200 or more and 300 or less, or a thermosetting grease is sealed in the grease-sealed space portion. With this arrangement, it is possible to ensure sufficient lubrication between the rollers and the sealing member, while retaining the rollers with the grease or thermosetting grease so as to effectively make the rollers less likely to fall off radially inward. In particular, since retention of the rollers is further enhanced by sealing the thermosetting grease in the grease-sealed space portion, it is possible to more smoothly insert the rotary shaft.

In the first arrangement and the second arrangement, a third arrangement may be used in which an average value of circumferential gaps between respective circumferentially adjacent pairs of the rollers is within a range of 0.003 mm or more and 0.020 mm or less. With this arrangement, it is possible to stably retain the rollers by grease sealed between the adjacent rollers while reducing an increase in rotational resistance between the adjacent rollers and preventing circumferential skewing of the rollers.

In the first arrangement to the third arrangement, a fourth arrangement may be used in which a sealed amount of grease sealed relative to a capacity of the grease-sealed space portion is within a range of 40% by volume or more and 120% by volume or less. With this arrangement, it is possible to ensure a sufficient amount of grease for maintaining good lubrication between the rollers and the rotary shaft and between the sealing member and the rotary shaft, and to reduce an increase in rotational resistance due to excessive grease.

### Effects of the Invention

According to the drawn cup needle roller bearing of the present invention, it is possible to ensure good lubrication between the rotary shaft and the sealing member by guiding grease sealed in the grease-sealed space portion toward the distal end of the seal lip of the sealing member while stably retaining the rollers so as to prevent the rollers from falling off radially inward. In addition, it is possible to seal a larger amount of grease by increasing the inner capacity of the grease-sealed space portion by an amount corresponding to the seal lip facing axially outward, thereby further enhancing lubrication. Further, it is possible to prevent entry of dust into the bearing and to avoid interference between the end surfaces of the rollers and the seal lip, thereby reducing an increase in sliding resistance.

### BRIEF DESCRIPTION OF THE DRAWINGS

FIG. 1 is a sectional view of a drawn cup needle roller bearing according to an embodiment of the present invention.

FIG. 2 is a sectional view taken along line II-II in FIG. 1.

FIG. 3 is a sectional view of a portion of the drawn cup needle roller bearing shown in FIG. 1.

FIG. 4 is a sectional view showing a variation of rollers of the drawn cup needle roller bearing shown in FIG. 3.

FIG. 5 is a sectional view showing a variation of sealing members of the drawn cup needle roller bearing shown in FIG. 3.

### BEST MODE FOR CARRYING OUT THE INVENTION

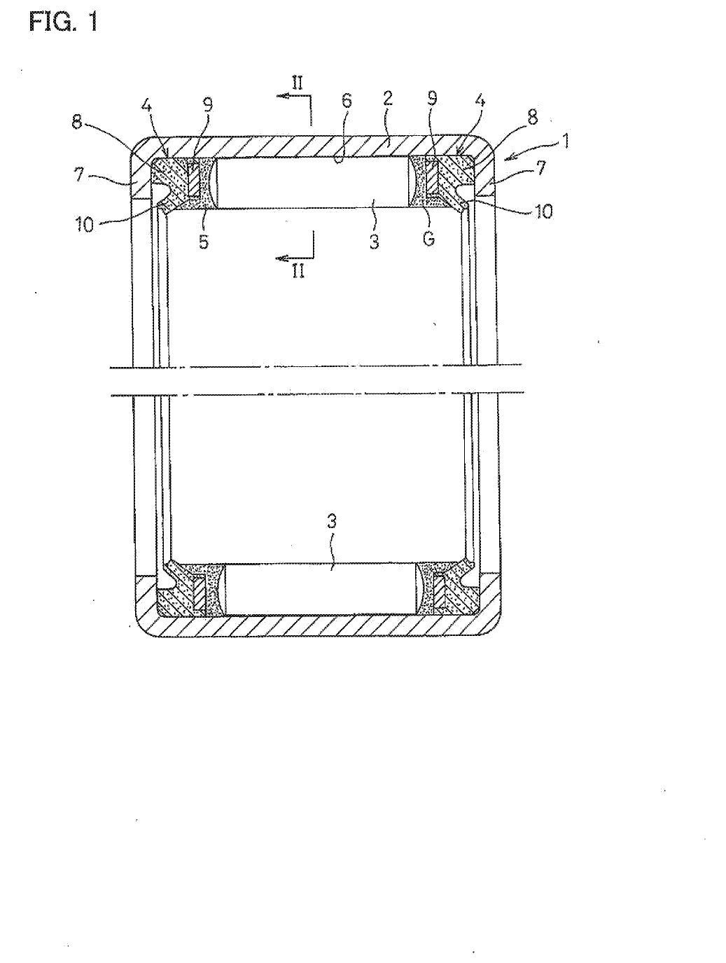

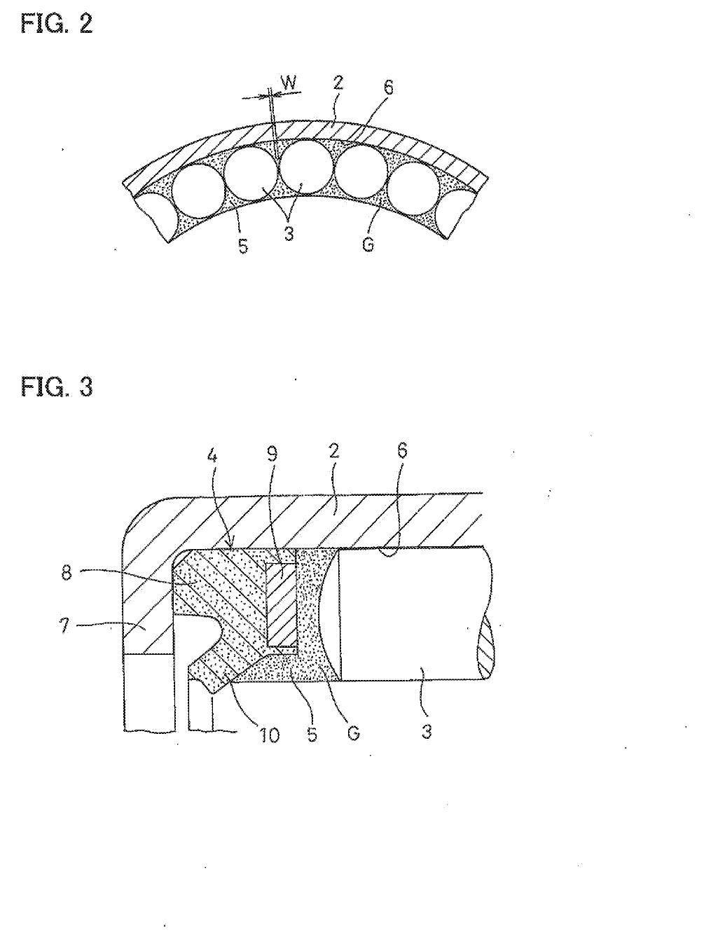

An embodiment of a drawn cup needle roller bearing according to the present invention will be described with reference to the accompanying drawings. This drawn cup needle roller bearing 1 is suitable for use in, in particular, swinging positions with small swinging angles or positions subjected to high loads, and is an open-end type full-complement drawn cup needle roller bearing that does not include a cage, and that includes, as shown in FIGS. 1 to 3, a shell 2 (hereinafter referred to as the “outer ring”, and the outer ring is denoted by the same reference numeral as used in the shell 2), a plurality of rollers 3 (hereinafter referred to as the “needle rollers”, and the needle rollers are denoted by the same reference numeral as used in the rollers 3), sealing members 4, and a grease-sealed space portion 5.

As used herein, the terms “axial direction”, “axial”, and “axially” refer to the direction along the center axis of the outer ring 2; the terms “radial direction”, “radial”, and “radially” refer to the direction perpendicular to the axial direction; and the terms “circumferential direction”, “circumferential”, and “circumferentially” refer to the direction along a circumference about the axial direction.

The outer ring 2 is a member including a cylindrical portion having a raceway surface 6 formed on the inner periphery, the raceway surface 6 having a radially-directed normal line, and the outer periphery of the cylindrical portion is fitted to a housing (not shown). Both axial ends of the outer ring 2 are formed, respectively, with two flanges 7 extending radially inward. In this embodiment, chromium-molybdenum steel (SCM) is used as the material for the outer ring 2; however a cold-rolled steel sheet (SPCC) or austenitic stainless steel (SUS) may be used.

The needle rollers 3 are disposed on the raceway surface 6, which is formed on the outer ring 2, and roll circumferentially on this raceway surface 6. Both ends of each needle roller 3 are rounded. By rounding these ends, the inner capacity of the grease-sealed space portion 5 is increased as compared with a case in which these ends are not rounded. Due to the increased inner capacity, it is possible to achieve preferable sealing, i.e., seal a larger amount of grease G. In this embodiment, high carbon chromium bearing steel is used as the material for the needle rollers 3.

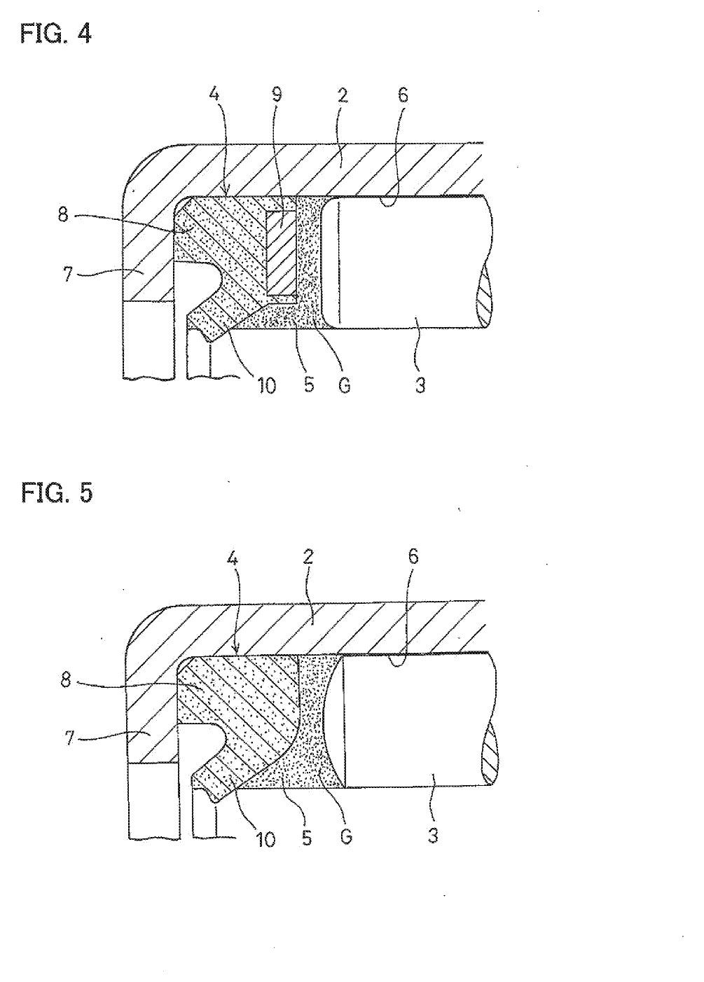

If the grease G has low consistency and thus provides strong adhesion, as shown in FIG. 4, needle rollers 3 each having both ends that have not been rounded, and thus having flat end surfaces may be used to reduce the cost for machining both ends of each needle roller 3.

In this embodiment, the design and size selection of relevant members are performed such that the average value of the circumferential gaps W between the respective circumferentially adjacent pairs of needle rollers 3 on the raceway surface 6 of the outer ring 2 is within the range of 0.003 mm or more and 0.020 mm or less. If this value is less than 0.003 mm, this could cause an increase in rotational resistance and insufficient lubrication between the adjacent needle rollers 3. If this value is greater than 0.020 mm, this could lead to a situation in which the needle rollers 3 are circumferentially skewed, and the effect of preventing the needle rollers 3 from falling off radially inward by the grease G is reduced. Accordingly, this value is preferably within the above range.

The sealing members 4 are disposed, respectively, on both axial ends of the raceway surface 6 of the outer ring 2. Each sealing member 4 includes an annular seal main body 8, a metal core 9 embedded in the seal main body 8, and a seal lip 10 extending radially inward from the radially inner side of the sealing member 4.

The distal end of the seal lip 10 faces outward in the axial direction away from the needle rollers 3. The distal end (radially inner end) of the seal lip 10 is in contact with the outer peripheral surface of a rotary shaft (not shown) inserted into this drawn cup needle roller bearing 1. By applying the grease G to the seal lip 10 in advance, the rotary shaft can be smoothly inserted, and rotational torque of the rotary shaft can be further reduced.

As the materials for the seal main body 8 and the seal lip 10 of each sealing member 4, for example, various rubbers can be used, such as heat-resistant and hydrogenated nitrile rubber, fluororubber, polyacrylate rubber, silicone rubber, and urethane rubber. As the material for the metal core 9, steel can be used. In this embodiment, the sealing members 4 each including the metal core 9 are used; however, if there is no problem regarding the rigidity of the sealing members 4, as shown in FIG. 5, sealing members 4 that do not include the metal cores 9 may be used.

The grease-sealed space portion 5 is a space portion in which grease G for lubricating the needle rollers 3 and the sealing members 4 can be sealed, and which is defined by the raceway surface 6 of the outer ring 2, the axial end surfaces and the peripheral surfaces of the needle rollers 3, the axial end surfaces of the sealing members 4 facing the needle rollers 3, and an imaginary cylindrical surface inscribed in the needle rollers 3, that is, the peripheral surface of the rotary shaft, which is disposed coaxially with the outer ring 2. The grease G is sealed in the grease-sealed space portion 5.

In this embodiment, a grease having a consistency within the range of 200 or more and 300 or less is used as the grease G. If the consistency is less than 200 (i.e., the grease is too stiff), this could prevent smooth lubrication of the needle rollers 3 and the sealing members 4.. If the consistency is greater than 300 (i.e., the grease is too soft), this could prevent stable retention of the needle rollers 3. Accordingly, the grease G preferably has a consistency within the above range.

When sealing the grease G, the sealed amount of grease G sealed relative to the capacity of the grease-sealed space portion 5 is set within the range of 40% by volume or more and 120% by volume or less. If the sealed amount is less than 40% by volume, lubrication between the needle rollers 3 and the sealing members 4 could be insufficient. If the sealed amount exceeds 120% by volume, excessive grease G could act as rotational resistance of the drawn cup needle roller bearing 1. Accordingly, the sealed amount is preferably within the above range.

When the sealed amount of grease is within the range of more than 100% by volume and not more than 120% by volume, a portion of the grease G cannot be fully accommodated within the grease-sealed space portion 5. In this case, the portion of the grease G enters, for example, gaps between the flanges 7 of the outer ring 2 and the seal lips 10 of the sealing members 4, thereby contributing to prevention of entry of, e.g., dust through gaps between the radially inner side of the seal lips 10 and the rotary shaft, improvement of lubrication in the vicinities of the seal lips 10, and the like.

In addition, a thermosetting grease may be used for lubrication. The thermosetting grease is a lubricant containing, as its main components, a grease having lubricating properties and super-high-molecular polyethylene. The thermosetting grease is in a normal grease state at ordinary temperature, and, once the grease is heated and then cooled (baking treatment), the grease solidifies with a large amount of lubricant retained therein. Then, the retained lubricant exudes from the thermosetting grease due to a rise in temperature or friction accompanying use of the drawn cup needle roller bearing 1, thereby lubricating the needle rollers 3 and the sealing members 4. By applying this thermosetting grease to the full-complement drawn cup needle roller bearing 1, it is possible to enhance retention of the needle rollers 3 and to more smoothly insert the rotary shaft.

When manufacturing this drawn cup needle roller bearing 1, a thin plate is first subjected to precision deep drawing to form the outer ring 2, and the axial ends of the outer ring 2 are bent radially inward to form the two flanges 7. Next, the sealing members 4 are fitted to the inner sides of the two flanges 7, respectively, such that the distal ends of the seal lips 10 face outward. Further, a predetermined amount of grease G is sealed between the two sealing members 4 (on the radially inner surface of the outer ring 2), a predetermined number of needle rollers 3 are embedded in the grease G at predetermined intervals, thereby completing the drawn cup needle roller bearing 1.

With respect to the drawn cup needle roller bearing 1 according to the present invention, the distal end of the seal lip 10 of the sealing member 4 disposed between the needle rollers 3 and at least one of the two flanges 7 on the shell 2 (outer ring 2) faces outward in the axial direction away from the needle rollers 3, and the grease-sealed space portion 5 is defined such that grease G for lubricating the needle rollers 3 and the sealing member 4 can be sealed therein. Therefore, it is possible to ensure good lubrication between the rotary shaft and the sealing member 4 by guiding the grease G, which is sealed in the grease-sealed space portion 5, toward the distal end of the seal lip 10 of the sealing member 4 while stably retaining the needle rollers 3 with the grease G so as to prevent the needle rollers 3 from falling off radially inward. In addition, it is possible to seal a larger amount of grease G by increasing the inner capacity of the grease sealing space portion 5 by an amount corresponding to the axially outward extension of the distal end of the seal lip 10, thereby further enhancing lubrication. Further, it is possible to prevent entry of dust into the bearing and to avoid interference between the end surfaces of the needle rollers 3 and the seal lip 10, thereby reducing an increase in sliding resistance.

In addition, with respect to the drawn cup needle roller bearing 1 according to the present invention, since a grease G having a consistency within the range of 200 or more and 300 or less is sealed in the grease-sealed space portion 5, it is possible to ensure sufficient lubrication between the needle rollers 3 and the sealing member 4, while retaining the needle rollers 3 with the grease G so as to effectively make the needle rollers 3 less likely to fall off radially inward. In particular, since retention of the needle rollers 3 is further enhanced by sealing the thermosetting grease in the grease-sealed space portion 5, it is possible to more smoothly insert the rotary shaft.

Further, with respect to the drawn cup needle roller bearing 1 according to the present invention, since the average value of the circumferential gaps between the respective circumferentially adjacent pairs of needle rollers 3 is within the range of 0.003 mm or more and 0.020 mm or less, it is possible to stably retain the needle rollers 3 by grease G sealed between the adjacent needle rollers 3 while reducing an increase in rotational resistance between the adjacent needle rollers 3 and preventing circumferential skewing of the needle rollers 3.

Further, with respect to the drawn cup needle roller bearing 1 according to the present invention, since the sealed amount of grease G sealed relative to the capacity of the grease-sealed space portion 5 is within the range of 40% by volume or more and 120% by volume or less, it is possible to ensure a sufficient amount of grease for maintaining good lubrication between the needle rollers 3 and the rotary shaft and between the sealing member 4 and the rotary shaft, and to reduce an increase in rotational resistance due to excessive grease G.

While an arrangement is exemplified above in which the shell 2 is an outer ring 2, and the raceway surface 6 is formed on the inner periphery of the outer ring 2, an arrangement may be used in which the shell 2 is an inner ring 2, and the raceway surface 6 is formed on the outer periphery of the inner ring 2. In this arrangement, too, it is possible to achieve the same (or substantially the same) effects as described above .

In addition, while, from the viewpoint of prevention of dust entry and retention of grease G, the sealing members 4 are preferably disposed at both axial ends of the bearing, depending on the manner of use of the drawn cup needle roller bearing 1, an arrangement may be used in which the sealing member 4 is disposed at only one axial end of the bearing.

The above-described embodiment is a mere example in every respect, and the present invention is not limited thereto. The scope of the present invention is indicated by not the above description but the claims, and should be understood to include all modifications within the meaning and scope equivalent to the scope of the claims.

### DESCRIPTION OF REFERENCE NUMERALS

1: Drawn cup needle roller bearing
2: Shell (Outer ring)
3: Roller (Needle roller)
4: Sealing member
5: Grease-sealed space portion
6: Raceway surface
7: Flange
8: Seal main body
9: Metal core
10: Seal lip
G: Grease
W: Circumferential gap (between rollers)

1. A drawn cup needle roller bearing of a full-complement type comprising:
a shell having a raceway surface formed on an inner periphery or an outer periphery of the shell, the shell including two flanges formed at two axial ends of the shell, respectively;
a plurality of rollers received in the shell;
a sealing member disposed between the rollers and at least one of the two flanges, the sealing member having a distal end formed with a seal lip; and
a grease-sealed space portion defined by the raceway surface of the shell, axial end surfaces and peripheral surfaces of the rollers, an axial end surface of the sealing member facing the rollers, and an imaginary cylindrical surface inscribed in or circumscribed about the rollers and located on a radially opposite side from the raceway surface with respect to a pitch circle diameter of the rollers,
wherein grease for lubricating the rollers and the sealing member is sealed in the grease-sealed space portion, and a distal end of the seal lip faces axially outward.

2. The dawn cup needle roller bearing according to claim 1, wherein a grease having a consistency within a range of 200 or more and 300 or less, or a thermosetting grease is sealed in the grease-sealed space portion.

3. The drawn cup needle roller bearing according to claim 1, wherein an average value of circumferential gaps between respective circumferentially adjacent pairs of the rollers is within a range of 0.003 mm or more and 0.020 mm or less.

4. The drawn cup needle roller bearing according to claim 1, wherein a sealed amount of grease sealed relative to a capacity of the grease-sealed space portion is within a range of 40% by volume or more and 120% by volume or less.

5. The drawn cup needle roller bearing according to claim 2, wherein an average value of circumferential gaps between respective circumferentially adjacent pairs of the rollers is within a range of 0.003 mm or more and 0.020 mm or less.

6. The drawn cup needle roller bearing according to claim 2, wherein a sealed amount of grease sealed relative to a capacity of the grease-sealed space portion is within a range of 40% by volume or more and 120% by volume or less.

7. The drawn cup needle roller bearing according to claim 3, wherein a sealed amount of grease sealed relative to a capacity of the grease-sealed space portion is within a range of 40% by volume or more and 120% by volume or less.
